(19) United States
(12) Patent Application Publication
(10) Pub. No.: US 2024/0033970 A1
(43) Pub. Date: Feb. 1, 2024

(54) System and Method for a Cementitious Fiber Reinforced Building Material

(71) Applicant: Composite LLC, Pueblo, CO (US)

(72) Inventor: Michael Jeremy Pollock, Pueblo, CO (US)

(73) Assignee: Composite LLC, Pueblo, CO (US)

(21) Appl. No.: 18/216,108

(22) Filed: Jun. 29, 2023

Related U.S. Application Data
(60) Provisional application No. 63/369,465, filed on Jul. 26, 2022.

(51) Int. Cl. B28B 1/42; C04B 14/06; C04B 14/42; B28B 7/34; C04B 7/13

(52) U.S. Cl. CPC B28B 1/42; C04B 14/06; C04B 14/42; B28B 7/34; C04B 7/13

(57) ABSTRACT

A brick of cementitious fiber reinforced building material comprising may comprise a core surrounded by a mixture consisting essentially of about 40 wt % sand, about 5 wt % polymer, about 10 wt % water, about 32 wt % cement, about 8 wt % of a siliceous material, and about 3 wt % glass fiber. In some implementations, the core may be comprised of an expanded polystyrene (EPS) foam. The brick may optionally comprise at least one of a fiber glass mesh, a raceway, and a bonding agent.

### CROSS-REFERENCE TO RELATED APPLICATIONS

This application claims priority to U.S. Provisional Application No. 63/369,465 entitled “System and Method for a Cementitious Fiber Reinforced Building Material” to Michael Jeremy Pollock, filed on Jul. 26, 2022.

### BACKGROUND

### 1. Field of the Invention

The field of the present invention generally relates to the systems and methods for a cementitious fiber reinforced building material designed to provide a fully composite building material that is efficient, lightweight, and high strength for use in building and construction in place of or alongside traditional building materials such as masonry materials.

This invention generally relates to building materials used to construct a floor, a wall, an interior wall, an exterior wall, or a roof and may also be used as an applied finish such as a coating, a texture, a surface, or an appearance. The present invention includes bond beam and mortar applications. The present invention is also designed to accommodate or interface with typical construction related mechanical, electrical, and plumbing (MEP) raceway, reinforcements, and anchors.

This invention also generally relates to building materials that can be manufactured offsite, onsite, by kit, on demand, or 3D printing. The present invention also accommodates standardized sizing as well as custom cut to size and shape.

### 2. Description of Related Art

Existing building materials include composite sandwich panels and glass fiber reinforced cement (GFRC) shot through a mold that may also be used to make counter tops and benches.

### SUMMARY

The present invention provides among other things a cementitious fiber reinforced building material designed as a fully composite building material that is efficient, lightweight, and high strength.

Implementations of the cementitious fiber reinforced building material may comprise a typical footing, a brick, a beam, a mortar, or a combination of a typical footing, a brick, a beam, or a mortar. Particular aspects of the cementitious fiber reinforced building material may include a typical footing comprising a footing and a footing reinforcement such as an anchor or a rebar.

Implementations of the cementitious fiber reinforced building material may be configured to comprise a brick comprising a core, a mix with fiber glass, and optionally a raceway, a brick reinforcement, or a brick anchor. One aspect of the cementitious fiber reinforced building material may include a core configured as an EPS core. Another aspect of the cementitious fiber reinforced building material may include a mix with fiberglass comprising a fiber glass mesh and a mix further comprising a glass fiber, a sand, a polymer, and a bonding agent.

One implementation of the cementitious fiber reinforced building material may be configured as a beam comprising a reinforced rebar core, a beam mix, a beam bonding agent, and optionally a beam reinforcement such as a beam anchor, a beam sleeve, and a beam post such as a beam rebar.

Another implementation of the cementitious fiber reinforced building material may be configured as a mortar comprising a mortar mix and a mortar bonding agent.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 representatively illustrates a side view of an embodiment of a brick depicting an optional sleeve for anchoring and identifying a possible location for installation of a beam.

FIG. 2 representatively illustrates a top view of an embodiment of a brick depicting optional reinforcement locations such as a sleeve or post and possible beam location.

FIG. 3 depicts a general process diagram of an embodiment of a method for using a cementitious fiber reinforced building material.

FIG. 4 depicts a general process diagram of an embodiment of a method for making a cementitious fiber reinforced building material.

FIG. 5 representatively illustrates a perspective view of an embodiment of a cementitious fiber reinforced building material manufacturing facility and supporting equipment.

FIGS. 6-9 are tables showing coupon testing data for the disclosed brick with and without a fiber glass mesh included in the brick.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

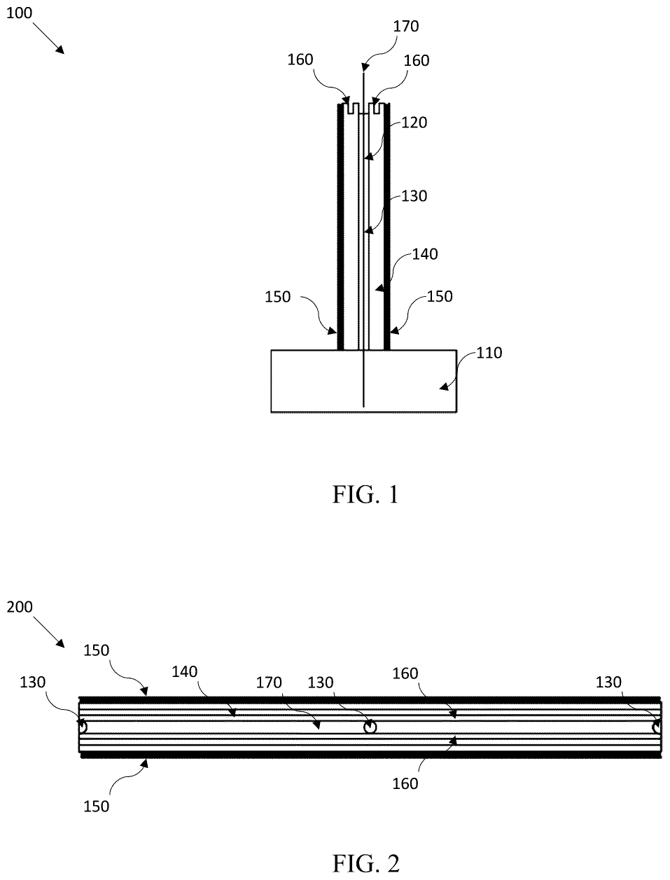

In one application, a cementitious fiber reinforced building material 100 provides a fully composite building material that is efficient, lightweight, and high strength. In one embodiment, the cementitious fiber reinforced building material 100, may comprise a brick 200. In another embodiment, the cementitious fiber reinforced building material 100, may comprise a beam. In another embodiment, the cementitious fiber reinforced building material 100, may comprise a mortar. In another embodiment, the cementitious fiber reinforced building material 100, may comprise a brick 200 and a beam such as the beam location 170 shown on the brick 200 as shown in FIG. 1 and FIG. 2. In another embodiment, the cementitious fiber reinforced building material 100, may comprise a typical footing and a brick 200 as shown in FIG. 1. In another embodiment, the cementitious fiber reinforced building material 100, may comprise a typical footing and a beam. In another embodiment, the cementitious fiber reinforced building material 100, may comprise a typical footing, a brick 200, and a beam. In another embodiment, the cementitious fiber reinforced building material 100, may be configured with a typical footing, a brick 200, a beam, a mortar, or a combination of a typical footing, a brick 200, a beam, or a mortar. The cementitious fiber reinforced building material 100, may however, be configured in any suitable manner to provide building materials or interface with building materials.

The brick 200, according to various aspects of an embodiment of the invention provides a highly efficient composite building material. In one embodiment the brick 200, may comprise a core 140. In one embodiment the brick 200, may comprise a mix. In another embodiment the brick 200, may comprise a mix with fiber glass mesh 150. In another embodiment the brick 200, may comprise a core 140 and a mix with fiber glass mesh 150. In another embodiment the brick 200, may comprise a core 140, a mix with fiber glass mesh 150, and a finish coat comprising at least two layers of mix as shown in FIG. 1 and FIG. 2. In another embodiment, the brick 200 may be configured with a raceway 160. In another embodiment, the brick 200 may comprise a woven impact resistant fiberglass mesh strategically placed in a matrix such as a cement matrix at specific time and location in coating process to produce high tensile and shear strength materials. In another embodiment, the brick 200 may be configured with an additive, an inherent material property, or a specialization such as such as a fire suppressant, a water proofing, a resistance to mold, a resistance to termites, or a combination of specializations. In another embodiment, the brick 200 may be configured with a brick reinforcement such as a brick anchor, a brick sleeve 130, a brick post such as a brick rebar or the fiberglass rebar with mix 120. In another embodiment, the brick 200 may be configured to interface with a bonding agent such as a brick bonding agent, a beam bonding agent, a mortar bonding agent, or a footing bonding agent. In one application, the bonding agent, may be configured to molecularly bond the brick 200 such as a cementitious coating to an EPS core. In another application, the bonding agent, may be configured to be blended prior to mixing with any wet ingredients. In another application, the bonding agent, may be configured to be poured monolithically in field to tie reinforcement and the brick 200 together. In one application, the brick 200 may comprise an expanded polystyrene EPS core encapsulated with a proprietary infused cementitious fiber reinforced coating to form a highly efficient lightweight to high strength building material. In another application, the brick 200 may be precoated by screeding mix on to the sides of the core 140 while leaving an exposed perimeter such as to allow the brick 200 to be bonded to another brick 200 or other surface by a molecular composition during site assembly with a mix or other bonding material. In another application, the brick 200 maybe be configured to meet or exceed federal ratings, state ratings, county ratings, city ratings, or local ratings or building codes related requirements such as masonry ratings, wind and impact ratings, fire, flame, and smoke ratings, waterproof ratings, recyclability ratings, carbon footprint ratings, energy efficiency ratings, or other building related ratings, codes, or standards. In another embodiment, the brick 200 may comprise a mix and a fiber glass rebar reinforcement. In another embodiment, the brick 200 may comprise a mix, a fiber glass rebar reinforcement, and a bonding agent such as a bonding agent poured monolithically to bond the mix and the mix and the fiber glass rebar reinforcement. In another embodiment, the brick 200 may be configured, poured, and placed to meet pre-determined structural loads. In another embodiment, the brick 200 may be configured as coated by the mix, such as by a precoat of the mix by screeding the mix onto a side of a core such as an EPS panel such as by a coating machine. In another embodiment, the brick 200 may be configured with one side coated with mix, two sides coated with mix, more than two sides coated with mix. In another embodiment, the brick 200 may be configured coated once or more than once such as two layers of coating of the mix such as to provide additional strength and weight. In another embodiment, the brick 200 may be configured with recyclable materials. In another embodiment, the brick 200 may be configured with materials with minimum carbon footprint such as materials that do not require wood from trees to produce. In another embodiment, the brick 200 may comprise a sealed core. In another embodiment, the brick 200 may comprise a high insulation value core such as a high insulation core that provides a continuous insulation factor from the floor to the roof. In one application, the brick 200 may be configured as a type of brick such as a standardized size brick such as by non-limiting example, a standardized masonry brick, a tongue and groove brick, a vertically interlocking brick, a horizontally interlocking brick, a custom shape brick, or a combination of type of brick. In another application, the brick 200 may be configured as a type of brick designed based on the type, location, and use of the brick such as by a computer aid design (CAD). In another application, the brick 200 may be cut to size and shape by an automated tool such as hotwire computer numerical control (CNC) machinery, a manual tool, or a combination of tools. In another application, the brick 200 may be configured by the shape and size of a foam such as by a mold car. The brick 200, may however, be configured in any suitable manner to provide a building material or to facilitate connection, bond, attachment, or adherence to components of the cementitious fiber reinforced building material 100 or other related building materials.

The core 140, according to various aspects of an embodiment of the invention provides structure, stability, elasticity, insulation, and load bearing related to components of the cementitious fiber reinforced building material 100 or other related building materials. In one embodiment, the core 140 may be configured as a foam core such as an expanded polystyrene (EPS) foam core. In another embodiment, the core 140, may be configured as a waterproof core, such as a waterproof EPS core. In another embodiment, the core 140, may be configured as a foam such as an EPS foam with a high insulation (R) value. In another embodiment, the core 140, may be configured as a core with an R6 rating, such as an R6 per inch rating. In another embodiment, the core 140, may be configured to resist termites. In another embodiment, the core 140, may be configured to resist mold. In another embodiment, the core 140, may be configured with a fire suppressant incorporated into the core material such as a fire suppressant material that produces zero flame spread and about a 0 to about a 25 smoke development index. In another embodiment, the core 140, may be configured with variable width such as a width about 1.5″ wide, a width about less than 1″, a width about more than 1.5″, a width about 0.5″ to about 2″, or another width required by the application of the brick 200. In another embodiment, the core 140, may be configured with variable height such as about 4 ft tall, a height about less than 4 ft tall, a height about more than 4 ft tall, such as 8 ft tall, a height of 0.5″ to about 4 ft, or another height required by the application of the brick 200. In another embodiment, the core 140, may be configured with variable length such as a length about 8 ft long, a length about 16 ft long, a length of less than 8 ft long, a length less than 16 ft long, a length more than 16 ft long, a length about 0.5″ to about 16 ft long, or another length required by the application of the brick 200. In another embodiment, the core 140 may be configured with variable width, height, and length scaled relative to a custom size brick 200. In another embodiment, the core 140 may be configured as a sealed core. The core 140, may however, be configured in any suitable manner to provide support, stability, elasticity, insulation, or an interface for components of the cementitious fiber reinforced building material 100 or other related building materials.

The mix with fiber glass mesh 150, according to various aspects of an embodiment of the invention provides an efficient, lightweight, high strength support to the components of the brick 200. In one embodiment the mix with fiber glass mesh 150, may comprise a fiber glass mesh and a mix as shown FIG. 1 and FIG. 2.

In one embodiment, the fiber glass mesh may contain glass fibers. In another embodiment, the fiber glass mesh may be configured as a woven fiberglass mesh. In one embodiment, the fiber glass mesh may be configured as a stiff fiber glass mesh. In one embodiment, the fiber glass mesh may be configured as an alkaline resistant (AR) fiberglass. In another embodiment, the fiber glass mesh may be configured with a fiber glass mesh in a variable orientation such as a fiber glass mesh configured in the same direction, a fiber glass mesh in an angled orientation, a fiber glass mesh in a 90 degree orientation, fiber glass mesh in a random orientation such as an uncontrolled orientation, or a fiber glass mesh in about an optimal orientation suitable to the required strength of the brick 200 or other components of the cementitious fiber reinforced building material 100 or other related building materials.

In one embodiment, the mix may comprise a glass fiber, a sand, a polymer, and a bonding agent. In another embodiment, the mix may comprise a glass fiber, a sand, a polymer, a bonding agent, and a water. In some embodiments, the addition of an acrylic polymer to a wet mix may provide for additional curing strength and bonding. In another embodiment, a mix may comprise a glass fiber, a sand, a polymer, a bonding agent such as a brick bonding agent, and a cement such as a Portland cement. In another embodiment, the mix may comprise a glass fiber, a sand, a polymer, a bonding agent, and a siliceous material such as a pozzolan, an artificial pozzolan, a pumice, an ash, or a silica fume. In another embodiment, a mix may comprise a glass fiber, a sand, a polymer, a bonding agent, a water, a Portland cement, and a silicaeous material such as pozzolan. In another embodiment, the mix may be configured with a dry mix and a wet mix. In one embodiment, the dry mix may be configured with a dry sand, a dry polymer, a dry aggregate, a dry siliceous material, a dry glass fiber. In one embodiment, the wet mix may be configured as water such as about a 0.32 water to concrete ratio (w/c) or another water-cementitious ratio (w/cm). In one embodiment, the glass fiber may be configured as a chopped glass fiber. In another embodiment, the mix may be configured as a brick mix, a beam mix, or a mortar mix. In one application, a mix may be configured by a ratio of weight of mix components relative to the total weight of the brick 200 such as a total weight per batch of a brick 200 of about 82 lbs that might be configured with about 33.4 lbs of sand, about 3.9 lbs of polymer, about 8.8 lbs of water (at about 0.32 w/c), about 26.7 lbs of Portland cement (about 80%), about 6.7 lbs of pozzolan (about 20%), and about 2.5 lbs of alkaline resistant (AR) glass fibers. In one application, a mix may be configured by a ratio of percentage of mix components such as a mix may be configured with about 40.7% of sand, about 4.8% of polymer, about 10.7% of water, about 32.6% of cement, about 8.2% of a siliceous material such as pozzolan, and about 3.0% of fiber such as a glass fiber. The mix with fiber glass mesh 150, may however, be configured in any suitable manner to produce an efficient, lightweight, high strength support to the components of the brick 200. In some applications, the ratio mix may be varied for additional strengths by increasing the amounts of fiberglass and/or Portland cement relative to other components of the mix.

The chopped glass fiber, according to various aspects of an embodiment of the invention provides strength, support, and flexibility for the brick 200. In one embodiment, the chopped glass fiber, may be configured as a percentage by weight relative to the weight of the solid, such as about 3% of chopped glass fiber of total weight of non-fiber materials, such as about 2.5 lbs of polymer when the total weight of the brick is about 82 lbs. In another embodiment, the chopped glass fiber may be configured with chopped glass fibers in a variable amount such as a low chopped glass fiber content, a medium chopped glass fiber content, a high chopped glass fiber content, or a customized chopped glass content suitable to the required strength of the mix. The glass fiber, may however, be configured in any suitable manner to provide a resistance to load, improved strength, flexibility, and reinforcement of the system 100 components.

The sand, according to various aspects of an embodiment of the invention provides a binder, a filler, an improved strength, reduce voids, increase workability, increase volume, increases density, prevents shrinkage, inert material resistive to elements, and thermal expansion of components of the brick 200. In one embodiment the sand, may be configured as sandy aggregate such as an aggregate with sand, gravel, pebbles, or rocks. In another embodiment the sand, may be configured as a concrete sand. In another embodiment the sand, may be configured as a manufactured sand. In another embodiment the sand, may be configured as a variable size sand such as a small grain size sand, a medium grain size sand, a larger grain size sand, or a combination of grain sizes of sand. In another embodiment sand, may be configured as a sand with a smoother surface type, a sand with a coarser surface type, a sand with a jagged surface type, or a sand with a combination of surface types. In another embodiment sand, may be configured as an unwashed sand, a partially washed sand, a washed sand, an unscreened sand, a partially screened sand, or a screened sand. The sand, may however, be configured in any suitable manner to provide a component of the cementitious fiber reinforced building material 100.

The polymer, according to various aspects of an embodiment of the invention provide the brick 200 with improved tensile strength and flexural strength. In one embodiment, the polymer, may be configured as a dry polymer. In another embodiment, the polymer, may be configured as an acrylic polymer. In another embodiment, the polymer, may be configured as a copolymer. In another embodiment, the polymer, may be configured to molecularly bond with components of the brick 200 such as a cementitious coating to EPS core. In one application, the polymer, may be configured as a percentage by weight relative to the weight of the solid, such as about 6% of polymer at 51% of solids, such as about 3.9 lbs of polymer when the total weight of the brick 200 is about 82 lbs. The polymer, may however, be configured in any suitable manner to provide components of the brick 200 with additional properties, strength, and flexibility.

The raceway 160, according to various aspects of an embodiment of the invention provides for incorporation of vertical or horizontal pathways within or around components of the cementitious fiber reinforced building material 100. In one embodiment the raceway 160, may comprise any suitable system for creating an area within the brick 200 for installation of construction related components such as a channel or a conduit as shown in FIG. 1 and FIG. 2. In one embodiment the raceway 160, may be configured as a mechanical, electrical, and plumbing (MEP) raceway. In one embodiment the raceway 160, may be configured to provide a pathway for a utility. In one embodiment the raceway 160, may be configured to provide an interface with a glass fiber rebar reinforcement. In another embodiment the raceway 160, may be configured to an interface with an anchoring detail. In one embodiment the raceway 160, may be configured to be incorporated into the brick 200 at the time of manufacture of the brick 200. In another embodiment the raceway 160, may be configured to be incorporated into the brick 200 at the time of installation of the brick 200, such as on the construction site. The raceway 160, may however, be configured in any suitable manner to provide pathways for utilities, reinforcements, details, or an interface for components of the cementitious fiber reinforced building material 100 or other related building materials.

The beam, according to various aspects of an embodiment of the invention provides a horizontal structural element that may improve the strength or anchorage of a structure such as a wall when the structure may not be otherwise backed by a floor or a roof structure. In one embodiment the beam, may comprise a mix and a fiber glass reinforced rebar core. In another embodiment the beam, may comprise a mix, a fiber glass reinforced rebar core, and a foam wrap. In another embodiment the beam, may be configured as a manufactured pre-stressed cast in place beam wrapped in EPS foam meant to carry the live and dead loads of the roofing structure and where placement might tie directly into vertical reinforcement provided by cavities in a brick 200 originating from a footing 110. In another embodiment the beam, may be configured of a foam “form” where the mix and the fiberglass rebar reinforced core are placed and poured to meet structural gravity loads. In another embodiment the beam, may be configured to interface with the bonding agent such as the brick bonding agent, the beam bonding agent, the mortar bonding agent, or the footing bonding agent. In another embodiment, the brick 200 may be configured as a bond beam. In another embodiment, the brick 200 may be configured as a beam designed to adequately hold the loads of any roofing structure and to be able to transfer them into the sleeve anchors tied to footing. The beam, may however, be configured in any suitable manner to provide support, structure, or an interface for components of the cementitious fiber reinforced building material 100 or other related building materials.

The mortar, according to various aspects of an embodiment of the invention provides for bonding components of the cementitious fiber reinforced building material 100. In one embodiment, the mortar may comprise the mix. In one embodiment, the mortar may comprise the mix and the mortar bonding agent. In one embodiment the mortar, may be configured as a joint such as a substantially vertical joint, a substantially horizontal joint, a substantially angled joint, or a substantially non-linear joint, a rack, or a beader. In another embodiment, the mix may be configured as a mortar that creates a joint such as a vertical joint such as a header joint, a horizontal joint such as a bead joint, another type of joint such as a concave joint, a “vee” (V) joint, a flush joint, a raked joint, an extruded joint, a beaded joint, a struck joint, a weathered joint, a squeezed joint, a struck joint, or an combination of types of joints. In another embodiment, the mortar may be configured as a mortar substrate. In another embodiment, the mortar may be configured as a mortar designed to create a bond with the brick 200, such as a composite bond or a molecular bond. In another application the mortar, may be configured as a mortar designed to create a bond between more than one brick 200, such as bonding a first exposed EPS perimeter on a first brick 200 to a second exposed EPS perimeter on a second brick 200 either configured as bonding the two bricks side by side to each other, or bonding the two bricks top to bottom to each other. In another embodiment, the mortar may be configured to bond a brick 200 on one side, bond a brick 200 on two sides, bond a brick 200 on three sides, bond a brick 200 on four sides such as a side-by-side and top to bottom configuration, bond a brick 200 on a fifth side such as a front to back configuration, or bond a brick 200 on a six side such as a back to front configuration. In another embodiment the mortar, may be configured as a screed such as a layer designed to give a smooth and level surface and take up variations in flatness and levelness on the base it is laid. In one embodiment, the mortar, may be configured as a coating such as a coting used as a head bead or a title bead to a bond brick 200, a beam, or other components of the cementitious fiber reinforced building material 100 together. The mortar, may however, be configured in any suitable manner to facilitate connection, bond, attachment, or adherence to components of the cementitious fiber reinforced building material 100 or other related building materials.

The typical footing, according to various aspects of an embodiment of the invention provides for a foundation or surface for the cementitious fiber reinforced building material. In one embodiment, the typical footing may comprise a footing 110. In another embodiment a typical footing, may comprise a footing 110 and a footing reinforcement. In one embodiment, the footing reinforcement may be configured as a footing anchor such as a fastener, a footing sleeve such as a sleeve configured to interface with the fiber glass rebar with mix 120, or a footing post, such as a footing rebar as shown in FIG. 2. In one application, the typical footing may be configured with substantially vertical footing reinforcement configured to interface a mating brick sleeve 130 such that a footing post might be positioned at about 4′ on center and a mating brick sleeve 130 also positioned at about 4′ on center, a footing post might be positioned at about 32″ on center and a mating brick sleeve 130 also positioned at about 32″ on center, or a footing post might be positioned at about 16″ on center and a mating brick sleeve 130 also positioned at about 16″′ on center. In another embodiment the typical footing, may be configured to interface with the bonding agent such as the brick bonding agent, the beam bonding agent, the mortar bonding agent, or the footing bonding agent. The typical footing, may however, be configured in any suitable manner to provide a support, a foundation, or an interface for components of the cementitious fiber reinforced building material 100 or other related building materials.

In one application, the cementitious fiber reinforced building material 100 may be configured as a matrix such as a pattern of a brick 200, a beam, a mortar, or a combination of components of the cementitious fiber reinforced building material 100. In another application, the cementitious fiber reinforced building material 100 may be configured as a wythe comprising a brick 200 with at least 2 layers of the mix. In another application, the cementitious fiber reinforced building material 100 may be configured as a brick 200 configured as a beam such as a bond beam. In another application, the cementitious fiber reinforced building material 100 may be configured as a brick 200 configured with a scrim.

In another application, the cementitious fiber reinforced building material 100 may be configured as a structure such as a floor, a wall such as a masonry wall, an interior wall, an exterior wall, or a roof, an applied finish such as a coating, a texture, a surface, or an appearance, or a type of building material such as a brick 200 or a beam.

In another application, the cementitious fiber reinforced building material 100 may be configured with a footing configured with a footing integrated reinforcement such as a substantially vertical footing reinforcement such as a footing sleeve, a substantially vertical footing anchor, a footing post tension, or a footing post such as substantially vertical footing rebar or a substantially horizontal footing reinforcement such as a substantially horizontal footing anchor or a substantially horizontal rebar, or a substantially angled footing reinforcement.

In another application, the cementitious fiber reinforced building material 100 may be configured with a brick 200 configured with a brick integrated reinforcement such as a substantially vertical brick reinforcement such as a brick sleeve 130, a substantially vertical brick anchor, a brick post tension, or a brick post such as substantially vertical brick rebar or a substantially horizontal brick reinforcement such as a substantially horizontal brick anchor or a substantially horizontal rebar, or a substantially angled brick reinforcement as shown in FIG. 1 and FIG. 2.

In another application, the cementitious fiber reinforced building material 100 may be configured with a beam configured with a beam integrated reinforcement such as a substantially vertical beam reinforcement such as a beam sleeve, a substantially vertical beam anchor, a beam post tension, or a beam post such as substantially vertical beam rebar or a substantially horizontal beam reinforcement such as a substantially horizontal beam anchor or a substantially horizontal rebar, or a substantially angled beam reinforcement.

In another application, the cementitious fiber reinforced building material 100 may be configured with an integrated reinforcement placed at a standardized spacing, a variable spacing, or a combination of standardized and variable spacing. In another application, the cementitious fiber reinforced building material 100 may be configured with a combination of a footing integrated reinforcement and a brick integrated reinforcement.

In another application, the cementitious fiber reinforced building material 100 may be configured with a finished coat such as a fiberglass scrim such as a fiberglass fabric, a fiberglass gauze, or a fiberglass textile with the mix to provide a wrap for a larger section.

In another application, the cementitious fiber reinforced building material 100 may be configured with a high modulus of elasticity to overall low weight ratios to produce a product that is highly resistant to earthquake, hurricanes, and other natural or man-made phenomena. In another application, the cementitious fiber reinforced building material 100 may be configured as a lightweight, high tensile, and high sheer strength material.

In another application, the cementitious fiber reinforced building material 100 may be configured to interface with a 3D printing process, such as 3D printing a home. In another application, the cementitious fiber reinforced building material 100 may be configured to be used in place of or alongside masonry such as a precoated brick used as masonry wall.

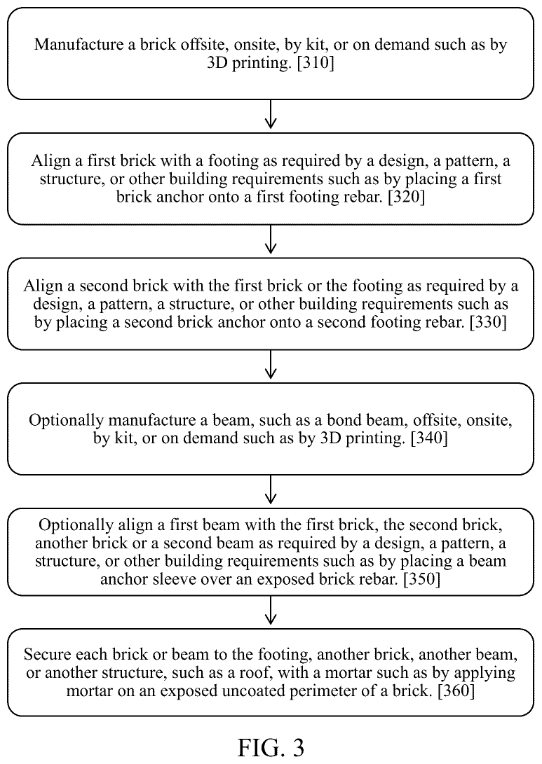

The cementitious fiber reinforced building material 100 according to various aspects of an embodiment of the invention provides for the manufacture a brick offsite, onsite, by kit, or on demand such as by 3D printing 310; alignment of a first brick with a footing as required by a design, a pattern, a structure, or other building requirements such as by placing a first brick anchor onto a first footing rebar 320; alignment of a second brick with the first brick or the footing as required by a design, a pattern, a structure, or other building requirements such as by placing a second brick anchor onto a second footing rebar 330; optionally manufacturing a beam, such as a bond beam, offsite, onsite, by kit, or on demand such as by 3D printing 340; optionally aligning a first beam with the first brick, the second brick, another brick or a second beam as required by a design, a pattern, a structure, or other building requirements such as by placing a beam anchor sleeve over an exposed brick rebar 350; and securing each brick or beam to the footing, another brick, another beam, or another structure, such as a roof, with a mortar such as by applying mortar on an exposed uncoated perimeter of a brick 360 as shown in FIG. 3.

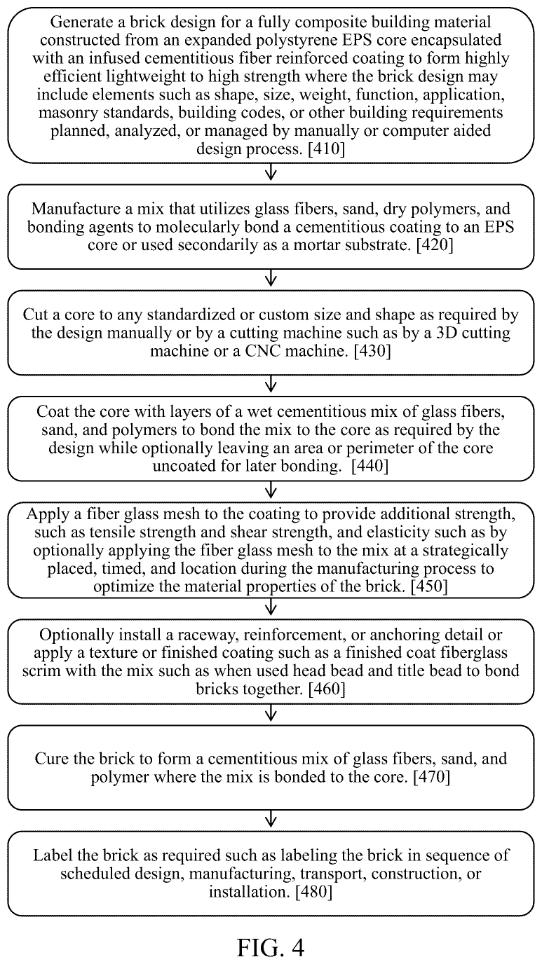

The cementitious fiber reinforced building material 100 according to various aspects of an embodiment of the invention provides for generating a brick design for a fully composite building material constructed from an expanded polystyrene EPS core encapsulated with an infused cementitious fiber reinforced coating to form highly efficient lightweight to high strength where the brick design may include elements such as shape, size, weight, function, application, masonry standards, building codes, or other building requirements planned, analyzed, or managed by manually or computer aided design process 410; manufacturing a mix that utilizes glass fibers, sand, dry polymers, and bonding agents to molecularly bond a cementitious coating to an EPS core or used secondarily as a mortar substrate 420; cutting a core to any standardized or custom size and shape as required by the design manually or by a cutting machine such as by a 3D cutting machine or a CNC machine 430; coating the core with layers of a wet cementitious mix of glass fibers, sand, and polymers to bond the mix to the core as required by the design while optionally leaving an area or perimeter of the core uncoated for later bonding 440; applying a fiber glass mesh to the coating to provide additional strength, such as tensile strength and shear strength, and elasticity such as by optionally applying the fiber glass mesh to the mix at a strategically placed, timed, and location during the manufacturing process to optimize the material properties of the brick 450; optionally install a raceway, reinforcement, or anchoring detail or apply a texture or finished coating such as a finished coat fiberglass scrim with the mix such as when used head bead and title bead to bond bricks together 460; curing the brick to form a cementitious mix of glass fibers, sand, and polymer where the mix is bonded to the core 470; and labelling the brick as required such as labeling the brick in sequence of scheduled design, manufacturing, transport, construction, or installation 480 as shown in FIG. 4.

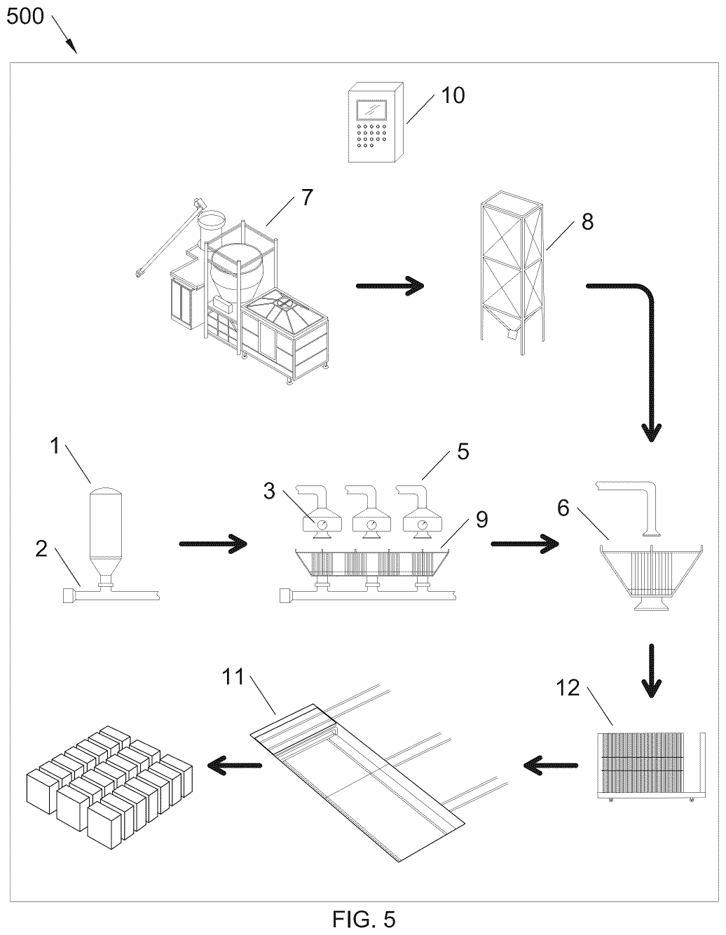

of an embodiment of the invention provides for a manufacturing system configured with supporting equipment such as a mix materials silo 1 such as a cement silo and a polymer silo; a screw conveyor 2 such as a screw conveyor used to deliver materials to a location to prepare for batching; a scale 3 such as a scale used to weigh the cement, the polymer, a strand such as a fiberglass strand or fiberglass mesh, and any other required materials; a batching plant 4 such as a batching plant used for combining dry materials in exact weights and measurements; a mixing system 5 such as a mixing system for mixing a dry matrix with water and plasticizers; a material discharging hopper 6 such as a material discharging hopper that the mix is dispersed into; an core material pre-expander 7 such as an EPS pre-expander creating full production of EPS panels starting from the moulding stage; an core material silo 8 such an EPS silo that houses a bulk EPS virgin bead used in the expander to form blocks of EPS; an aggregate measuring bunker 9; a controlling room 10 such as a controlling room for housing manufacturing and test related instruments, gauges, screens and levers to operate a facility; a ferry trolley 11 such as a ferry trolly that provides transport of a molds from start to finish; a mold car 12 such as a car for transporting molds where the mold is related to size or cut of different brick designs or as standardized sizes such as 4′, 8′, or 16′ tall or placing a fiber glass mesh; optionally a calcium silicate panel inserting platform 13 such as a calcium silicate panel used for stamping texture or desired finishes into a brick; and a de-mold traveling crane 14 such as a crane used to remove each brick from a mold as shown in FIG. 5.

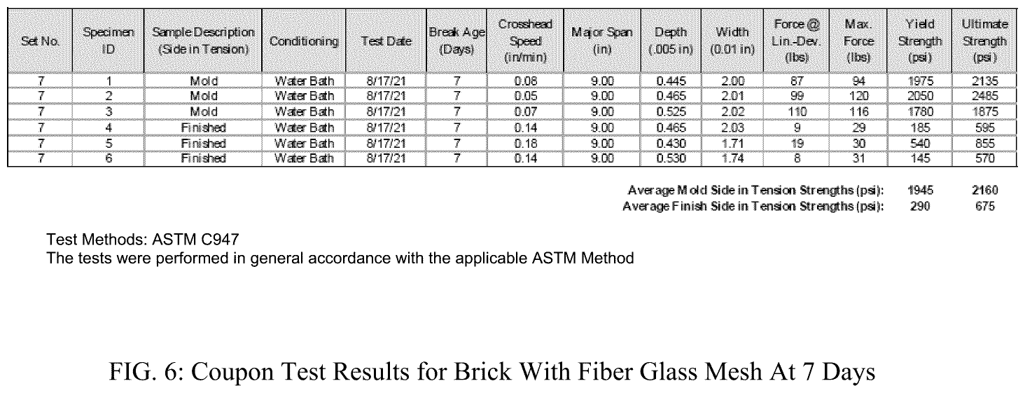

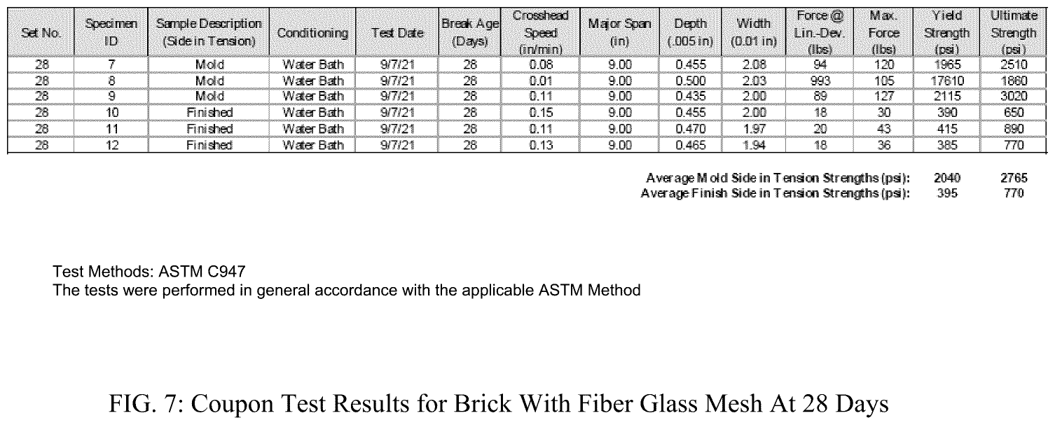

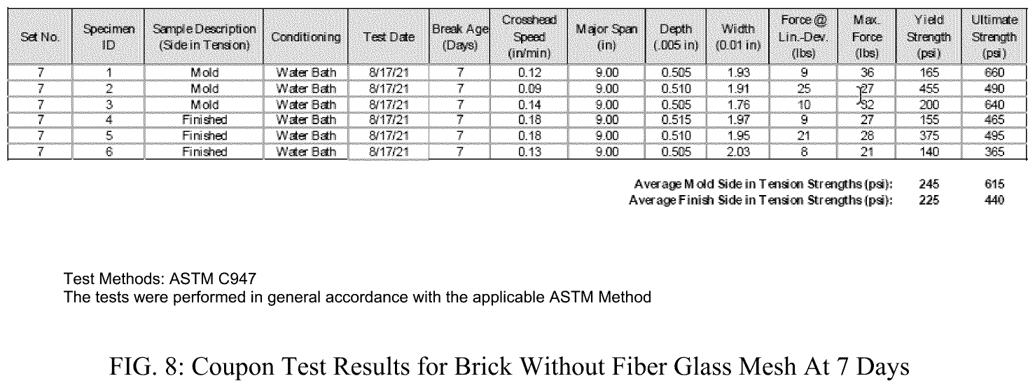

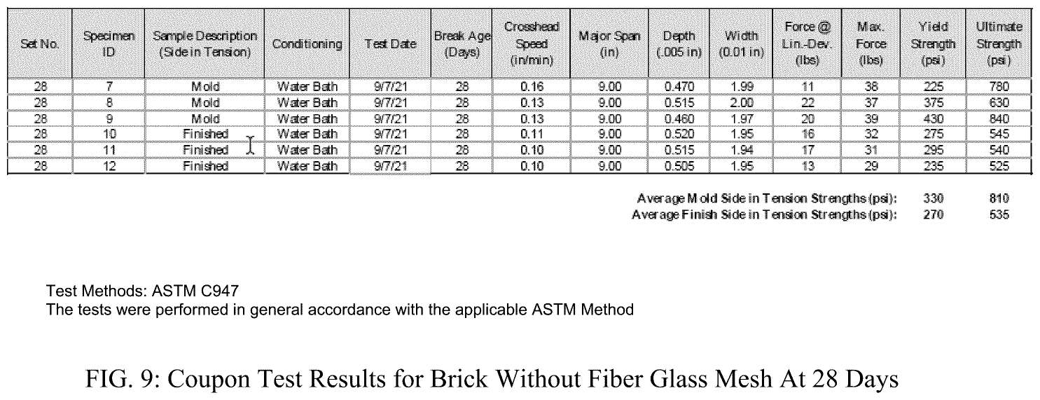

FIGS. 6-9 provide exemplary results of independent lab testing of the flexural properties of the brick as disclosed in the subject application both with and without the inclusion of a fiber glass mesh.

In places where the description above refers to particular implementations of systems and methods for a cementitious fiber reinforced building material, it should be readily apparent that a number of modifications may be made without departing from the spirit thereof and that these implementations may be applied to other to systems and methods for a cementitious fiber reinforced building material.

I claim:

1. A brick of cementitious fiber reinforced building material comprising:
a core surrounded by a mixture consisting essentially of:
about 40 wt % sand;
about 5 wt % polymer;
about 10 wt % water;
about 32 wt % cement;
about 8 wt % of a siliceous material; and
about 3 wt % glass fiber.

2. The brick of cementitious fiber reinforced building material of claim 1, wherein the mixture consists essentially of:
40.7 wt % sand;
4.8 wt % polymer;
10.7 wt % water;
32.6 wt % cement;
8.2 wt % of a siliceous material; and
3 wt % glass fiber.

3. The brick of cementitious fiber reinforced building material of claim 1, wherein the siliceous material is pozzolan.

4. The brick of cementitious fiber reinforced building material of claim 1, wherein the sand is aggregated with one or more of gravel, pebbles, and rocks.

5. The brick of cementitious fiber reinforced building material of claim 1, wherein the polymer is at least one of a dry polymer, an acrylic polymer, and a copolymer.

6. The brick of cementitious fiber reinforced building material of claim 1, wherein the core is comprised of an expanded polystyrene (EPS) foam.

7. The brick of cementitious fiber reinforced building material of claim 6, wherein the core is configured to have at least one of the following: an R6 insulation rating, termite resistance, mold resistance, and a fire suppressant.

8. The brick of cementitious fiber reinforced building material of claim 1, further comprising a fiber glass mesh.

9. The brick of cementitious fiber reinforced building material of claim 1, further comprising a raceway running along a length of the brick and configured to provide a pathway for at least one of a utility, a reinforcement, and an anchoring detail.

10. The brick of cementitious fiber reinforced building material of claim 1, further comprising a bonding agent configured to bond the mixture to the core.

11. A method of manufacturing a brick of cementitious fiber reinforced building material, the method comprising:
creating a mixture consisting essentially of:
about 40 wt % sand;
about 5 wt % polymer;
about 10 wt % water;
about 32 wt % cement;
about 8 wt % of a siliceous material; and
about 3 wt % glass fiber;
surrounding a core with the mixture; and
curing the mixture.

12. The method of claim 11, wherein the mixture consists essentially of:
40.7 wt % sand;
4.8 wt % polymer;
10.7 wt % water;
32.6 wt % cement;
8.2 wt % of a siliceous material; and
3 wt % glass fiber.

13. The method of claim 11, wherein the siliceous material is pozzolan.

14. The method of claim 11, wherein the sand is aggregated with one or more of gravel, pebbles, and rocks.

15. The method of claim 11, wherein the polymer is at least one of a dry polymer, an acrylic polymer, and a copolymer.

16. The method of claim 11, wherein the core is comprised of an expanded polystyrene (EPS) foam.

17. The method of claim 16, wherein the core is configured to have at least one of the following: an R6 insulation rating, termite resistance, mold resistance, and a fire suppressant.

18. The method of claim 1, further comprising integrating the mixture with a fiber glass mesh.

19. The method of claim 1, further comprising creating a raceway running along a length of the brick, the raceway configured to provide a pathway for at least one of a utility, a reinforcement, and an anchoring detail.

20. The method of claim 1, further comprising adding a bonding agent to the mixture to bond the mixture to the core.
